(19) United States
(12) Patent Application Publication
(10) Pub. No.: US 2018/0285022 A1
(43) Pub. Date: Oct. 4, 2018

(54) MEMORY SYSTEM, MEMORY MANAGEMENT METHOD AND SEMICONDUCTOR DEVICE

(71) Applicant: LAPIS Semiconductor Co., Ltd., Yokohama (JP)

(72) Inventor: Toshiharu OKADA, Yokohama (JP)

(73) Assignee: LAPIS Semiconductor Co., Ltd., Yokohama (JP)

(21) Appl. No.: 15/937,816

(22) Filed: Mar. 27, 2018

(30) Foreign Application Priority Data
Mar. 29, 2017 (JP) 2017-64935

(51) Int. Cl. G06F 3/06

(52) U.S. Cl. CPC G06F 3/0659; G06F 3/0679; G06F 3/064; G06F 3/0619

(57) ABSTRACT

A memory system of the present invention has a controller which, for each of a plurality of management groups each including k pieces of blocks (k is an integer equal to two or greater), produces physical block information correspondingly indicating state information indicative of no good when a no-good block is present within the management group. For each management group associated with the state information indicative of no good, the controller employs, as a reuse block, a block other than the no-good block among the k pieces of the blocks included in the management group, and when the total number of the reuse blocks is k, sets the k pieces of the reuse blocks as a new management group.

### BACKGROUND OF THE INVENTION

### 1. Field of the Invention

The present invention relates to a memory system that includes a memory and a controller for managing the memory, and to a memory management method for managing blocks of the memory.

### 2. Description of the Related Art

A NAND-type flash memory system has, other than a NAND-type memory cell, a controller for managing a memory address, and a random-access memory (RAM) for storing memory management information to be used to manage the address.

Known as a method for such address management is a method for independent management with a block serving as an erase unit or a page serving as a write unit.

For independent management, an increase in memory capacity causes an increase in proportion thereto in the size of management information required for address management. This may lead to an increase in the RAM size required, or make it impossible to store all the information at a time in the RAM.

In this context, to limit the size of the management information, a method for address management in the unit of a block group consisting of a plurality of blocks was suggested (for example, see Japanese Patent Application Laid-Open No. 2007-241896).

By the way, for address management in the unit of a block group consisting of a plurality of blocks, it is possible to assign a reduced number of bits to an address as compared with the case of address management in the single block unit.

However, for the address management in the block group unit, even when only one no-good block occurs in the block group, the entire block group has to be disabled. Therefore, since an apparent number of no-good blocks becomes greater than an actual number of no-good blocks, the storage capacity actually available is reduced.

### SUMMARY OF THE INVENTION

In this context, it is an object of the present invention to provide a memory system, a memory management method and a semiconductor device which reduce an increase in the capacity of management information so as to increase storage capacity available for actual use.

A memory system according to the present invention has a memory cell array with a plurality of blocks each including a plurality of memory cells, and a controller configured to, for each of a plurality of management groups each including k pieces of the blocks (k is an integer equal to two or greater), produce physical block information correspondingly indicating state information indicative of no good when a no-good block is present in the management group. The memory system is configured such that for each management group associated with the state information indicative of no good, the controller sets, as a reuse block, a block other than the no-good block among the k pieces of the blocks included in the management group, and when the total number of the reuse blocks is k, sets the k pieces of the reuse blocks as a new management group.

A memory management method according to the present invention is a method for managing a memory. The method includes: for each of a plurality of management groups each including k pieces of blocks (k is an integer equal to two or greater), producing physical block information correspondingly indicating state information indicative of no good when a no-good block is present in the management group; for each management group associated with the state information indicative of no good, setting as a reuse block, a block other than the no-good block among the k pieces of the blocks included in the management group; and when the total number of the reuse blocks is k, setting the k pieces of the reuse blocks as a new management group.

A semiconductor device according to the present invention has a controller configured to, for each of a plurality of management groups each including k pieces of blocks (k is an integer equal to two or greater), produce physical block information correspondingly indicating state information indicative of no good when a no-good block is present in the management group. The semiconductor device is configured such that for each management group associated with the state information indicative of no good, the controller sets, as a reuse block, a block other than the no-good block among the k pieces of the blocks included in the management group, and when a total number of the reuse blocks is k, sets the k pieces of the reuse blocks as a new management group.

In the present invention, for each management group consisting of k blocks (k is an integer equal to two or greater), the management group is managed as follows.

That is, in the present invention, when a no-good block is present in a management group, the state information indicating that the management group is no good is produced by being associated with the management group. For each management group with a no-good block present therein, other blocks excluding the no-good block among the k blocks included in the management group are set as reuse blocks. When the total number of the reuse blocks having been set for each management group is k, the k reuse blocks are set as a new management group.

Thus, even when the management group is unavailable because of the presence of a no-good block in the management group, a new management group is set using the other blocks excluding the no-good block and included in the management group.

Therefore, according to the present invention, it is possible to significantly reduce the apparent number of no-good blocks while limiting an increase in the capacity of management information. Furthermore, the efficiency of using blocks is significantly improved to provide an elongated memory service life. It is thus possible to substantially increase the storage capacity of a memory system, and reduce costs of the system with increasing memory service life.

### BRIEF DESCRIPTION OF THE DRAWINGS

FIG. 1 is a block diagram illustrating an example of a configuration of a memory system 100 according to the present invention;

FIG. 2 is a view illustrating an example of the contents of physical block information 201;

FIG. 3 is a view illustrating an example of the contents of a conversion table 202;

FIG. 4 is a view illustrating an example of the contents of a single reuse block information 401;

FIG. 5 is a flow chart illustrating an example of a management information update process;

FIG. 6 is a flow chart illustrating the example of the management information update process;

FIG. 7 is a flow chart illustrating an example of an access block number determination process;

FIG. 8 is a view illustrating an example of an update result of management information (201, 202, 401) by the management information update process;

FIG. 9 is a view illustrating an example of an update result of the management information (201, 202, 401) by the management information update process;

FIG. 10 is a block diagram illustrating another example of the configuration of the memory system 100 according to the present invention;

FIG. 11 is a view illustrating an example of the contents of management group information 501 and remainder block information;

FIG. 12 is a flow chart illustrating another example of the management information update process;

FIG. 13 is a flow chart illustrating the another example of the management information update process;

FIG. 14 is a flow chart illustrating another example of the access block number determination process;

FIG. 15 is a view illustrating an example of an update result of management information (201, 202, 501, 502) by the management information update process; and

FIG. 16 is a view illustrating an example of an update result of the management information (201, 202, 501, 502) by the management information update process.

### DETAILED DESCRIPTION OF THE INVENTION

A description will next be given of embodiments of the present invention with reference to the drawings.

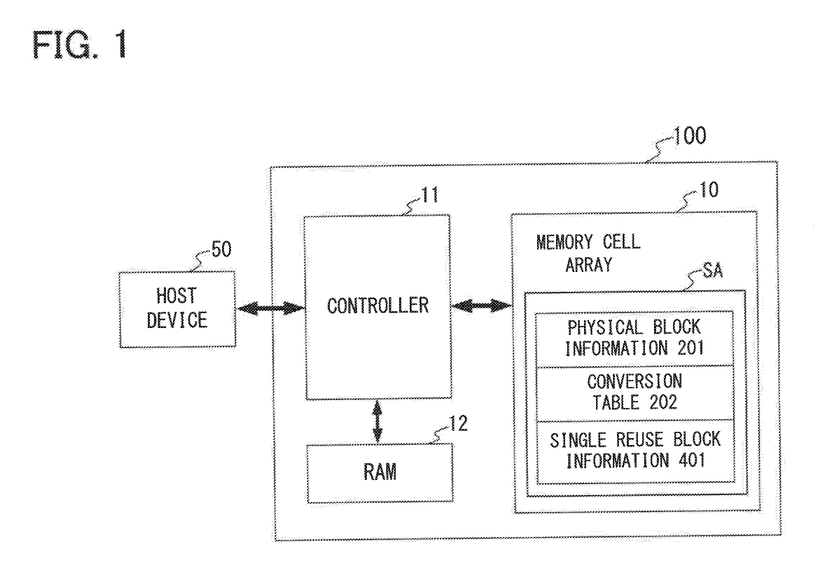

FIG. 1 is a block diagram illustrating an example of a configuration of a memory system 100 according to the present invention. As shown in FIG. 1, the memory system 100 has a memory cell array 10, a controller 11, and a Random-Access Memory (RAM) 12.

For example, the memory cell array 10 is a so-called NAND flash memory which typically includes a plurality of NAND type memory cells storing digital data. In the memory cell array 10, a plurality of memory cells form a page that serves as the minimum access unit, and a plurality of pages form a block. The memory cell array 10 has a plurality of such blocks formed therein.

In a storage region of the memory cell array 10, provided is a management information region SA for storing management information for managing a plurality of blocks in a management group unit that consists of k blocks (k is an integer equal to two or greater).

The management information includes physical block information 201, a conversion table 202, and single reuse block information 401.

For each aforementioned management group, the physical block information 201 is indicative of whether the management group is no good.

For example, the physical block information 201 includes state information and a physical ID, which are associated with each other. Here, the state information is indicative of “good” when all the blocks within the management group are in a good state and indicative of “no good” when even one no-good block is present within the management group, and the physical ID identifies the management group. Note that when the management group is no good, all the blocks that belong to the management group are not available for use.

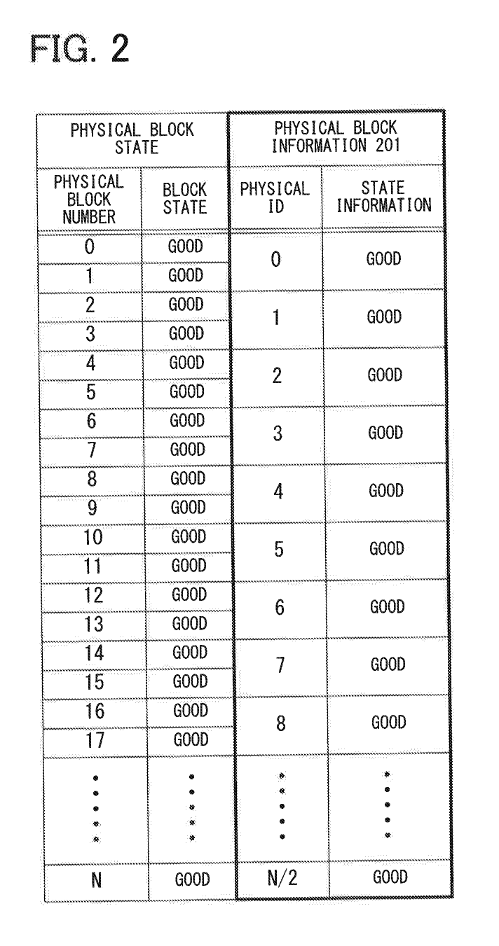

FIG. 2 is a view illustrating an example of the contents of the physical block information 201 at the factory prior to shipment.

In the example shown in FIG. 2, the number “k” of blocks constituting a management group is defined as “2,” and (N+1) blocks denoted by the physical block numbers “0” to “N” are divided into management groups, each consisting of two blocks. The management groups are each assigned one of “0” to “N/2” as a physical ID, and each physical ID is associated with the state information indicative of whether the group of blocks belonging to the physical ID is “no good” or “good.”

The conversion table 202 is to convert an address supplied from a host device 50, i.e., a logical address into a physical ID indicative of blocks in the memory cell array 10.

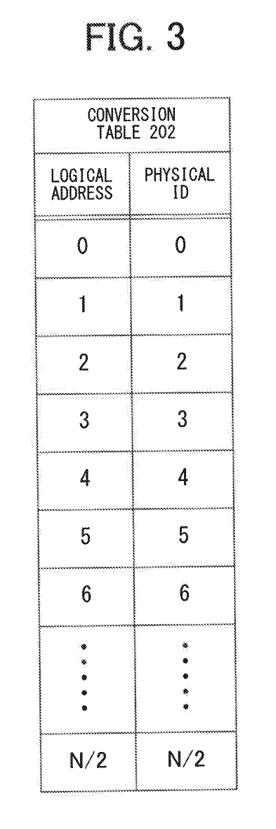

FIG. 3 is a view illustrating an example of the contents of the conversion table 202 at the factory prior to shipment. As shown in FIG. 3, at the factory prior to shipment, for example, the converted physical IDs (0) to (N/2) corresponding to the logical addresses (0) to (N/2) are set as the conversion table 202.

The single reuse block information 401 represents the physical block number of a block (to be referred to as a reuse block) and a new physical ID associated therewith, the block being in a good state in a block group included in a management group that was treated as being “no good” because a block in a no-good state was included.

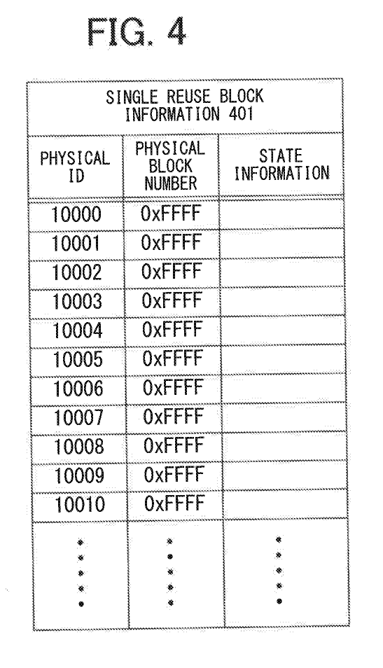

FIG. 4 is a view illustrating an example of the contents of the single reuse block information 401 at the factory prior to shipment.

As shown in FIG. 4, at the factory prior to shipment, the single reuse block information 401 includes an identification code [0xFFFF] indicative of non-assignment, which is associated with each of physical IDs of which value increases by one, for example, from [10000], as a physical ID that is not used in the physical block information 201.

In response to the power supply being turned on, the controller 11 reads management information stored in the management information region SA of the memory cell array 10, that is, the physical block information 201, the conversion table 202, and the single reuse block information 401, to be store in the RAM 12.

Subsequently, upon reception of various types of command signals (such as a read command and a write command), an address, and data sent out from the host device 50, the controller 11 accesses the memory cell array 10 to read, write, and erase data.

The controller 11 may write on the memory cell array 10 in response to a write access from an external device such as the host device 50. In the case of unsuccessful writing, the controller 11 senses the block including the unsuccessfully written memory cell as a no-good block. On the other hand, before data written on a memory cell is corrupted, the controller 11 performs a refresh process. It is to be noted that the refresh process successively performed once per a block. That is, the controller 11 performs the refresh process for copying the data to another block which is different in position from the block to which the memory cell belongs. When data is written unsuccessfully on a memory cell of the another block in the refresh process, the controller 11 also senses the block including the unsuccessfully written memory cell as a no-good block.

Upon sensing an unsuccessfully written no-good block, the controller 11 executes the management information update process described below.

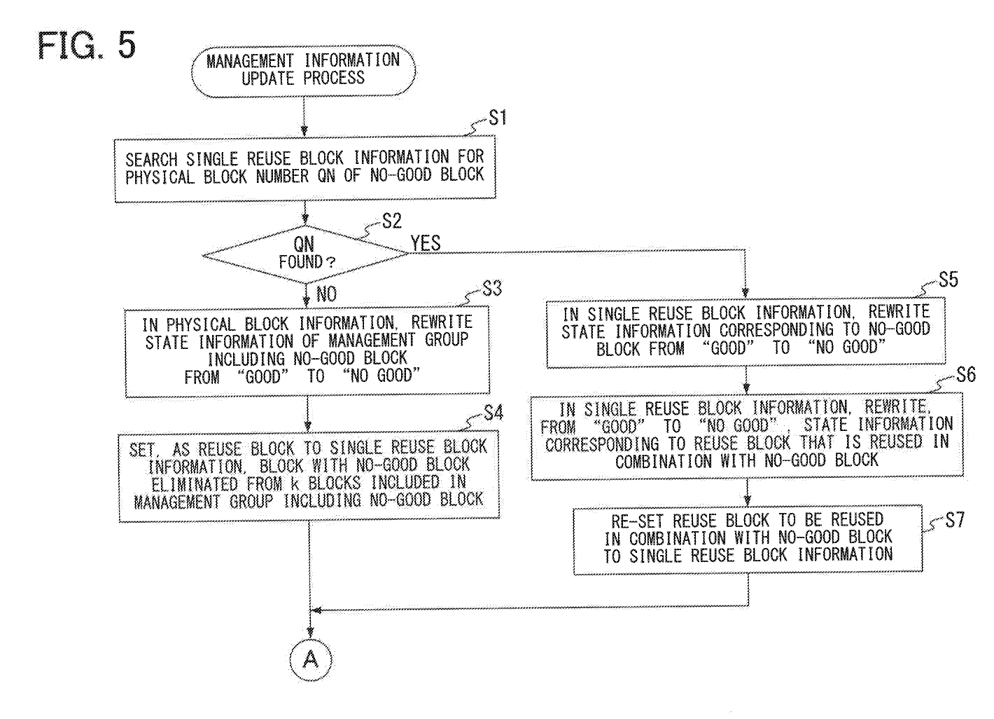

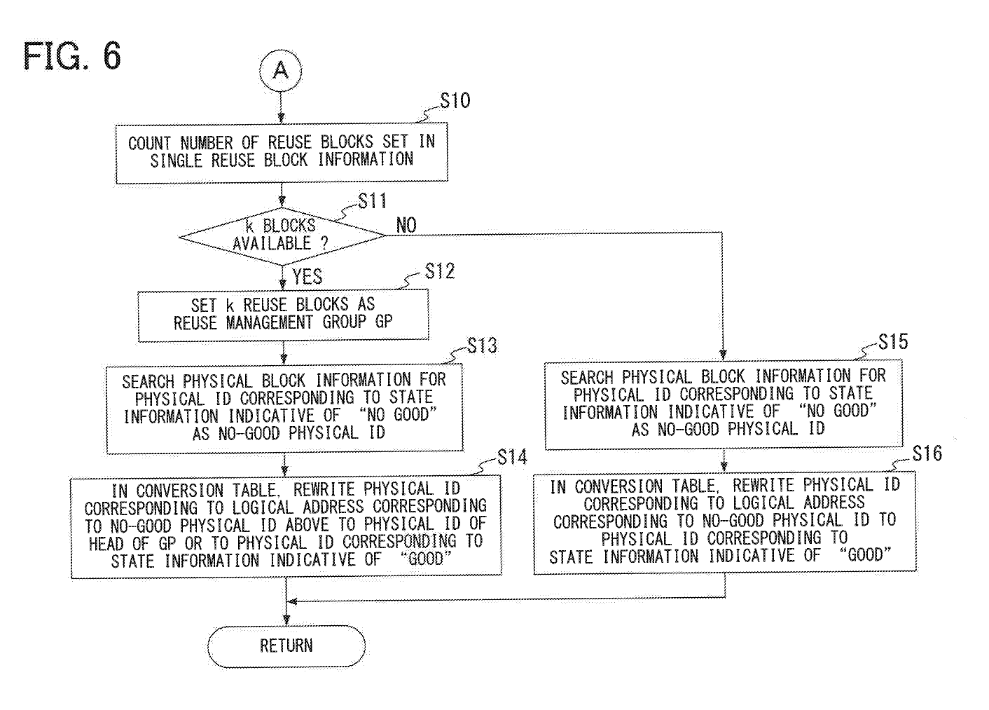

FIGS. 5 and 6 are a flow chart illustrating an example of the management information update process.

First, the controller 11 searches the single reuse block information 401 stored in the RAM 12 for the physical block number of the aforementioned no-good block as a physical block number QN (step S1). In this search, the controller 11 determines whether the physical block number QN is found in the single reuse block information 401 (step S2).

In step S2, if it is determined that the physical block number QN is not found in the single reuse block information 401, then in the physical block information 201, the controller 11 rewrites the state information of the management group including the no-good block, that is, the state information of the physical ID corresponding to the physical block number QN from “good” to “no good” (step S3).

Then, the controller 11 sets the blocks with a no-good block eliminated from the k blocks included in a management group including a no-good block as a reuse block to the single reuse block information 401 (step S4). More specifically, the controller 11 appends, to the single reuse block information 401, each physical block number associated with the state information indicative of “good” with QN excluded from the physical block numbers that belong to the physical ID corresponding to the physical block number QN.

Note that if it is determined in the aforementioned step S2 that the physical block number QN is present in the single reuse block information 401, then the controller 11 rewrites, from “good” to “no good,” the state information corresponding to the no-good block in the single reuse block information 401 (step S5). That is, the controller 11 rewrites the state information of the physical ID corresponding to the physical block number QN from “good” to “no good.”

Then, in the single reuse block information 401, the controller 11 rewrites, from “good” to “no good,” the state information corresponding to a reuse block to be reused in combination with the no-good block (step S6). That is, the controller 11 rewrites, from “good” to “no good,” the state information corresponding to the physical block number to be reused in combination with the physical block number QN.

Then, the controller 11 re-sets the reuse block to be reused in combination with the no-good block to the single reuse block information 401 (step S7). More specifically, the controller 11 appends, as single reuse block information, a new physical ID associated with the physical block number to be reused in combination with the physical block number QN and the state information indicative of “good.”

After the aforementioned step S7 or S4 has been executed, the controller 11 counts the number of the reuse blocks set in the single reuse block information 401 (step S10), and determines whether the number of the reuse blocks is k (step S11).

In step S11, if it is determined that the number of the reuse blocks is k, then the controller 11 sets the k reuse blocks as a reuse management group GP (step S12).

Next, the controller 11 searches the physical block information 201 for a physical ID corresponding to the state information indicative of “no good” as a no-good physical ID (step S13).

Then, in the conversion table 202, the controller 11 rewrites the physical ID corresponding to the logical address corresponding to the no-good physical ID described above to either the head physical ID of the reuse management group GP or a physical ID corresponding to the state information indicative of “good” (step S14).

Note that in step S11, if it is determined that the number of the reuse blocks available is not k, then the controller 11 searches the physical block information 201 for a physical ID corresponding to the state information indicative of “no good” as a no-good physical ID (step S15).

Then, in the conversion table 202, the controller 11 rewrites the physical ID corresponding to a logical address corresponding to the no-good physical ID described above to a physical ID corresponding to the state information indicative of “good” (step S16).

Upon reception of the logical address sent out from the host device 50 after the aforementioned step S14 or S16 has been executed, the controller 11 executes an access block number determination process descried below. This allows for determining the physical block number indicative of a block to be accessed.

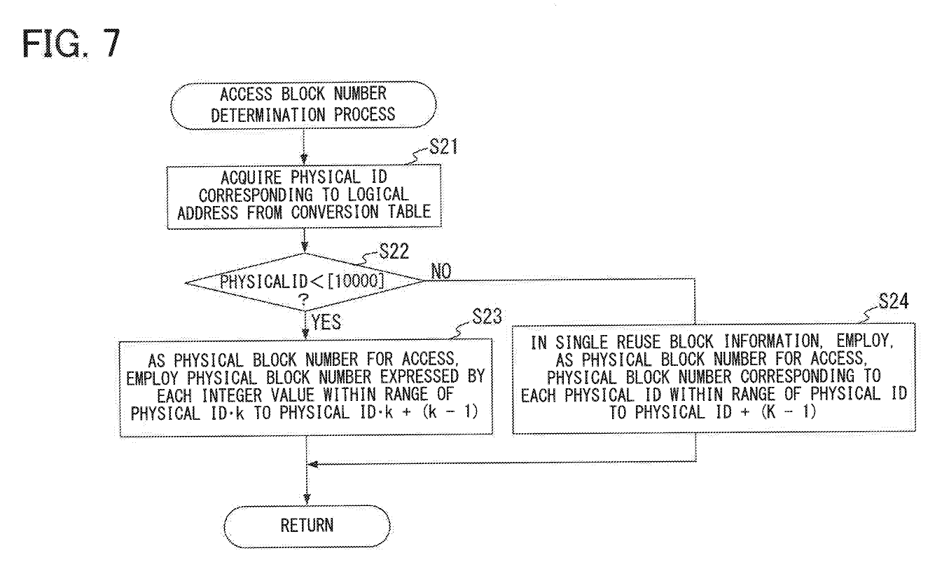

FIG. 7 is a flow chart illustrating an example of the access block number determination process.

In FIG. 7, the controller 11 acquires the physical ID corresponding to the logical address from the conversion table 202 (step S21).

Then, the controller 11 determines whether the acquired physical ID is less than, for example, [10000] shown as the head physical ID in the single reuse block information 401 (step S22).

In step S22, if it is determined that the acquired physical ID is less than [10000], then the controller 11 employs a physical block number expressed by each integer value within the range of the physical ID·k to the physical ID·k+(k−1) as a physical block number for access (step S23).

Note that in step S22, if it is determined that the acquired physical ID is not less than [10000], then the controller 11 employs the physical block number that is shown in the single reuse block information and corresponding to each physical ID within the range of the physical ID to the physical ID+(k−1), as a physical block number for access (step S24).

The controller 11 provides control to the memory cell array 10 so as to access (read or write) each block represented by the physical block number group acquired in the aforementioned step S23 or S24.

By way of example, a description will next be given of the management information update process and the access block number determination process in the case where the number of blocks or “k” in a management group serving as the minimum unit for managing the state of blocks is “2.”

### The Management Information Update Process

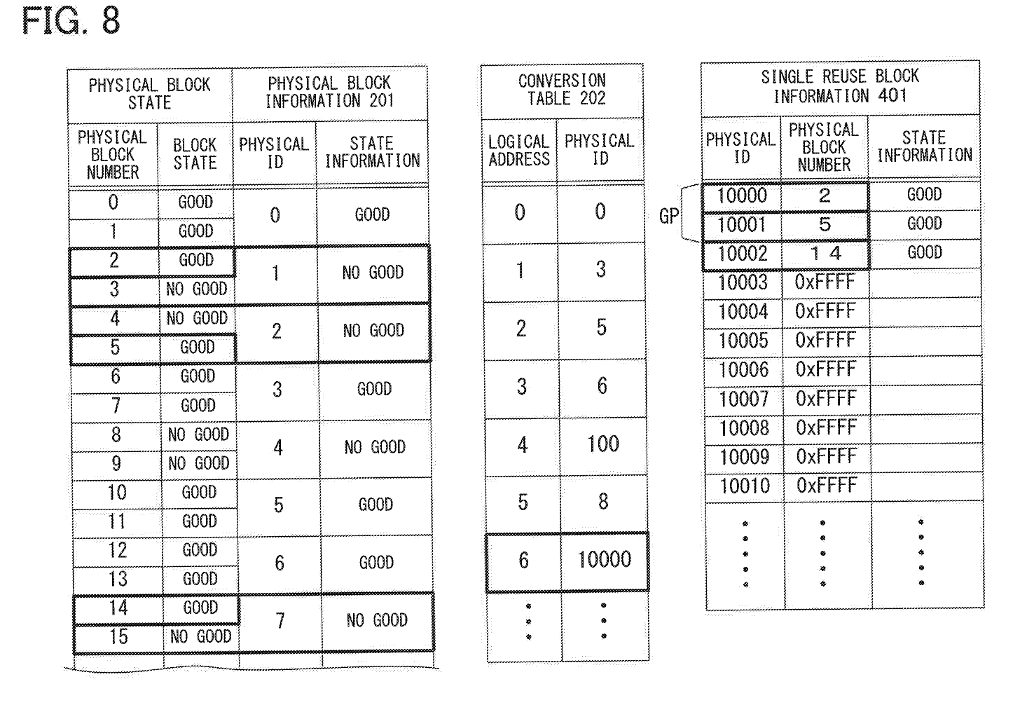

FIG. 8 is a view illustrating the contents of the management information (201, 202, 401) updated by the processing of the aforementioned steps S1 to S4 and S11 to S16 when each of the blocks of the physical block numbers “3,” “4,” “8,” “9,” and “15” is sensed as a no-good block.

In the example shown in FIG. 8, two consecutive physical block numbers that are adjacent to each other constitute one management group.

In FIG. 8, two blocks denoted by the physical block numbers “0” and “1” constitute a management group, and in the physical block information 201, are assigned “0” as the physical ID indicative of this management group. Since the two blocks denoted by the physical block numbers “0” and “1” corresponding to the physical ID “0” are both in a good state, the state information corresponding to the physical ID “0” remains as “good.”

The two blocks denoted by the physical block numbers “2” and “3” constitute a management group, and in the physical block information 201, are assigned “1” as the physical ID indicative of this management group. Of the physical block numbers “2” and “3” corresponding to the physical ID “1,” the block corresponding to the physical block number “2” is in a good state, but the block corresponding to the physical block number “3” is in a no-good state. Therefore, the state information corresponding to the physical ID “1” is rewritten to “no good.”

The two blocks denoted by the physical block numbers “4” and “5” constitute a management group, and in the physical block information 201, are assigned “2” as the physical ID indicative of this management group. Of the physical block numbers “4” and “5” corresponding to the physical ID “2,” the block corresponding to the physical block number “5” is in a good state, but the block corresponding to the physical block number “4” is in a no-good state. Therefore, the state information corresponding to the physical ID “2” is rewritten to “no good.”

The two blocks denoted by the physical block numbers “8” and “9” constitute a management group, and in the physical block information 201, are assigned “4” as the physical ID indicative of this management group. Since the physical block numbers “8” and “9” corresponding to the physical ID “4” are both in a no-good state, the state information corresponding to the physical ID “4” is rewritten to “no good.”

Furthermore, the two blocks denoted by the physical block numbers “14” and “15” constitute a management group, and in the physical block information 201, are assigned “7” as the physical ID indicative of this management group. Of the physical block numbers “14” and “15” corresponding to the physical ID “7,” the block corresponding to the physical block number “14” is in a good state, but the block corresponding to the physical block number “15” is in a no-good state. Therefore, the state information corresponding to the physical ID “7” is rewritten to “no good.”

By the way, all the pieces of state information corresponding to the aforementioned physical IDs “1,” “2,” and “7” are indicative of “no good”, but the management group corresponding to each of these physical IDs “1,” “2,” and “7” includes a block that is in a “good” state.

Therefore, the physical block numbers “2,” “5,” and “14” of the blocks that are in a “good” state and correspond to the physical IDs “1,” “2,” and “7,” respectively, are appended to the single reuse block information 401 corresponding to the head physical ID [10000], the next physical ID [10001], and the further subsequent physical ID [10002], respectively.

That is, each of the blocks expressed by the physical block numbers “2,” “5,” and “14” is set as a reuse block in the single reuse block information 401.

Thus, as shown in FIG. 8, the single reuse block information 401 includes the physical block numbers “2” and “5” indicative of two reuse blocks as the number of blocks constituting a management group. Thus, the reuse blocks expressed by these physical block numbers “2” and “5” constitute a reuse management group GP as a new management group.

As illustrated in the physical block information 201 of FIG. 8, the state information corresponding to the physical IDs “1,” “2,” “4,” and “7” is indicative of “no good.” In this case, a physical ID in a “no good” state in the conversion table 202 cannot be employed. In this context, in the conversion table 202, the physical IDs “1,” “2,” “4,” and “7” that are in a “no good” state are rewritten to the physical IDs associated with the state information indicative of “good” (steps S13 to S16).

For example, as shown in FIG. 8, the physical ID corresponding to the logical address “1” is rewritten to “3,” the physical ID corresponding to the logical address “2” is to “5,” and the physical ID corresponding to the logical address “3” is to “6.” Furthermore, as shown in FIG. 8, the physical ID corresponding to the logical address “6” is rewritten to the head physical ID [10000] of the reuse management group GP that is included in the single reuse block information 401.

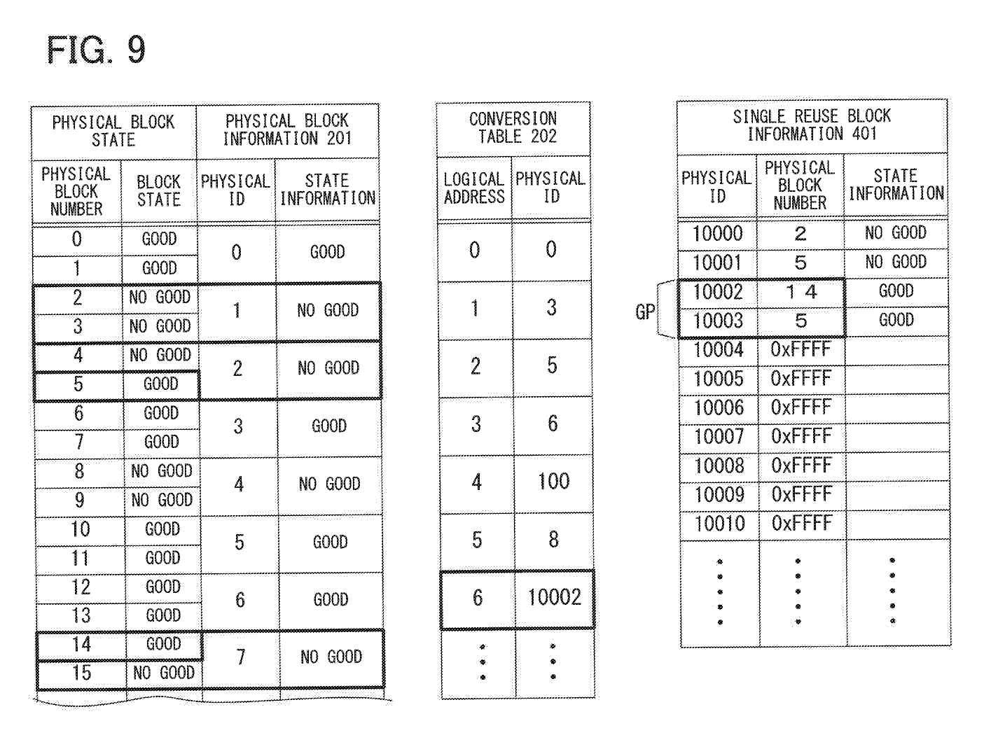

Like FIG. 8, FIG. 9 is a view illustrating the contents of the management information (201, 202, 401) when each block of the physical block numbers “3,” “4,” “8,” “9,” and “15” is sensed as a no-good block and the block of the physical block number “2” shown in the single reuse block information 401 is sensed as a no-good block.

Note that the update process based on the physical block numbers “3,” “4,” “8,” “9,” and “15” as a no-good block is the same as that shown in FIG. 8.

A description will next be given of the update process of the management information (201, 401) that is performed in the aforementioned steps S5 to S7 when the block of the physical block number “2” shown in the single reuse block information 401 is sensed as a no-good block.

When the block of the physical block number “2” is sensed as a no-good block, the state information corresponding to the physical block number “5” constituting the reuse management group GP in combination with the physical block number “2” is rewritten to “no good” in conjunction with the physical block number “2.” Note that since the block itself corresponding to the physical block number “5” is in a good state, the physical block number “5” is associated with the physical ID [10003] subsequent to the physical ID [10002] of the physical block number “14” and is then re-set to the single reuse block information 401.

This allows the two reuse blocks denoted by the physical block numbers “14” and “5” to be set as a new reuse management group GP.

Note that the aforementioned update of the management information (201, 401) is performed on both the RAM 12 and the management information region SA of the memory cell array 10.

### The Access Block Number Determination Process

First, a description will be given of the operation for determining the access block number in steps S21 to S24 shown in FIG. 7 using the management information (201, 202, 401) shown in FIG. 8 when the logical address “2” is supplied from the host device 50.

According to the conversion table 202 shown in FIG. 8, the physical ID corresponding to the logical address “2” is “5.” In this case, the physical ID is less than the head physical ID [10000] assigned to the single reuse block information 401. Therefore, the physical block number “10” having a value acquired by multiplying the physical ID “5” by “2” as the number k of blocks constituting the management group, and “11” are employed as an access block number.

A description will next be given of the operation for determining the access block number in steps S21 to S24 shown in FIG. 7 using the management information (201, 202, 401) shown in FIG. 8 when the logical address “6” is supplied from the host device 50.

According to the conversion table 202 shown in FIG. 8, the physical ID corresponding to the logical address “6” is [10000]. In this case, the physical ID is equal to or greater than the head physical ID [10000] assigned to the single reuse block information 401. Therefore, the physical block numbers “14” and “5,” which correspond to the physical ID [10000] and the physical ID [10001], respectively, and shown in the single reuse block information 401, are employed as an access physical block number.

As described above, in the memory system 100 shown in FIG. 1, for the memory cell array 10 in which a plurality of blocks each including a plurality of memory cells is formed, the controller 11 provides control as follows to each of the management groups each including k blocks.

First, for each of the plurality of management groups each including k blocks, the controller 11 produces the physical block information 201 shown by being associated with the state information indicative of “no good” when there exists a no-good block within the management group.

For each management group associated with the state information indicative of “no good” among the plurality of management groups, the controller 11 sets, as a reuse block, the blocks excluding a no-good block of the k blocks included in the management group to the single reuse block information 401. Then, when the total number of the reuse blocks set for each management group has reached k, the controller 11 sets the k reuse blocks as a new management group.

In a word, of the k blocks included in a management group that is treated as being in a no-good state only because at least one no-good block is included therein, the blocks in a good state other than the no-good block(s) are reused so as to set a new management group.

This makes it possible to significantly reduce the apparent number of no-good blocks while preventing an increase in the capacity of the management information. Furthermore, since the efficiency of using blocks is significantly improved, the service life of the memory is elongated and accordingly the system can be reduced in costs.

Furthermore, according to the single reuse block information 401, it is possible to check a list of physical block numbers indicative of a block in a good state among the plurality of blocks that belongs to the physical IDs that are treated as being no good. Therefore, according to the list, it is possible to set a new reuse management group GP without altering an already assigned reuse management group GP.

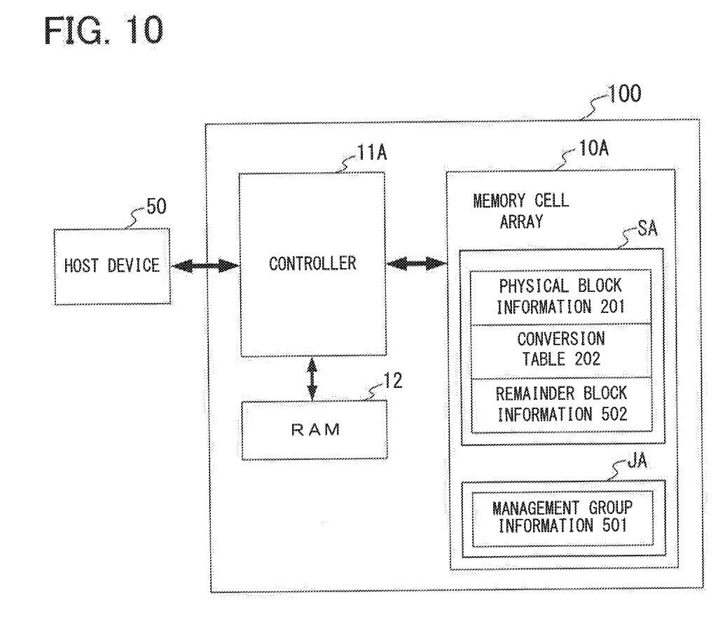

FIG. 10 is a block diagram illustrating another example of the configuration of the memory system 100 according to the present invention. The memory system 100 shown in FIG. 10 employs a controller 11A in place of the controller 11 shown in FIG. 1, and employs a memory cell array 10A in place of the memory cell array 10. The RAM 12 is the same as that shown in FIG. 1.

The memory cell array 10A is a NAND flash memory like the memory cell array 10. All the storage regions of a plurality of memory cells in the memory cell array 10A are provided with a management information region SA in which physical block information 201, a conversion table 202, and remainder block information 502, which serve as management information, are stored. In the memory cell array 10A, management group information 501 serving as management information is stored in a redundant region JA of at least one page that is included in each block.

The physical block information 201 and the conversion table 202 are the same as those shown in FIG. 1, and will not be described here again.

The management group information 501 indicates, for each of the management groups corresponding to each physical ID, the information indicative of the physical block number of a block that belongs to the management group.

Of the blocks in a good state excluding a no-good block included in the management group to which the aforementioned no-good block belongs, the remainder block information 502 indicates the physical block number of a “remainder” reuse block that could not be included in the reuse management group.

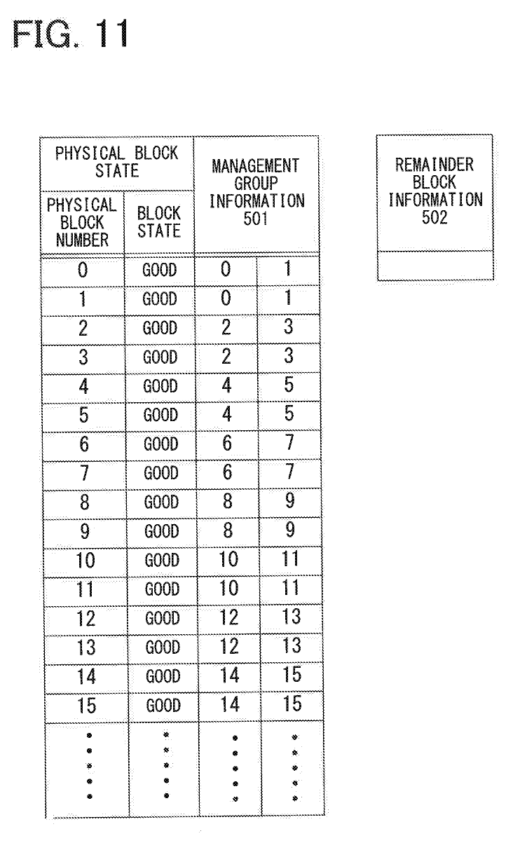

FIG. 11 is a view illustrating an example of the contents of the management group information 501 and the remainder block information 502 at the factory prior to shipment.

As shown in FIG. 11, for each physical block number, the management group information 501 indicates all the physical block numbers included in the management group to which the block of the physical block number belongs. Note that in this embodiment, since two blocks constitute a management group, two successive physical block numbers are illustrated by being associated with each physical block number. At the factory prior to shipment, the remainder block information 502 has no contents to be illustrated.

In response to the power supply being turned on, the controller 11A reads the physical block information 201, the conversion table 202, and the remainder block information 502, which are stored in the management information region SA of the memory cell array 10A, and stores the same in the RAM 12.

Subsequently, upon reception of various types of command signals (such as a read command or write command), addresses, and data, which are sent out from the host device 50, the controller 11A accesses the memory cell array 10A, for example, to read, write, or erase data.

When having unsuccessfully written on the memory cell array 10A in response to an access from an external device such as the host device 50, the controller 11A senses, as a no-good block, the block in which the unsuccessfully written memory cell is included.

When having sensed a no-good block that is an unsuccessfully written block as mentioned above, the controller 11A executes the management information update process described below.

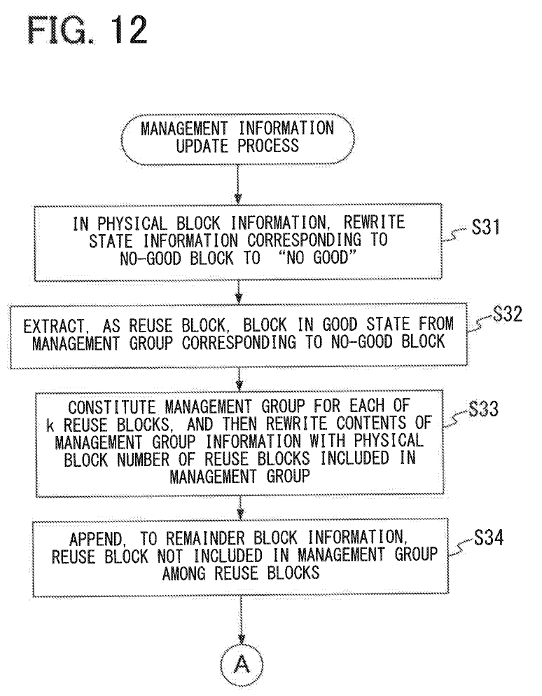

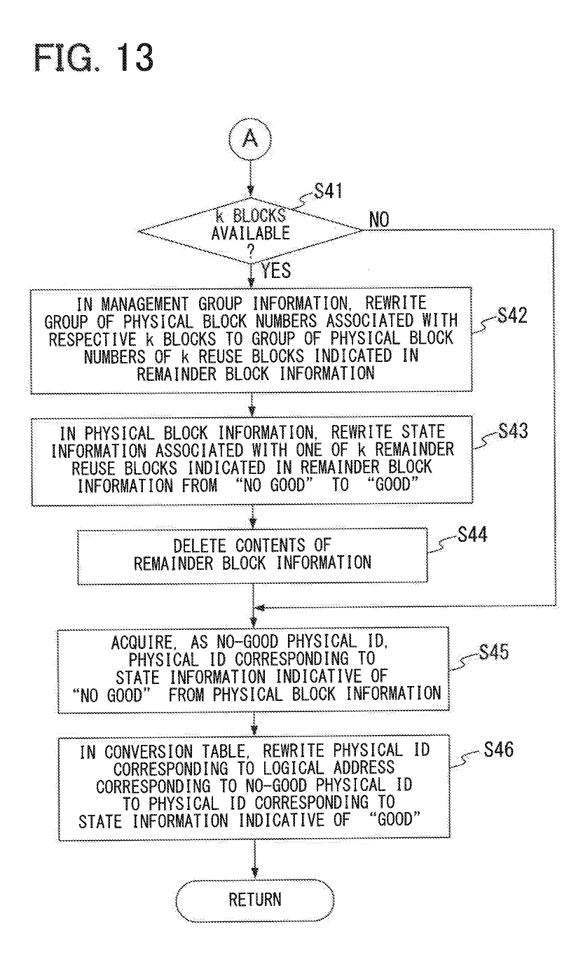

FIGS. 12 and 13 are a flow chart illustrating an example of the management information update process.

First, in the physical block information 201, the controller 11A rewrites the state information of the physical ID corresponding to a no-good block to “no good” (step S31).

Then, the controller 11A extracts, as a reuse block, a block in a good state from the management group corresponding to the no-good block (step S32). That is, the controller 11A extracts the physical block number of a block in a good state from the group of blocks that belong to the physical ID indicative of the no-good block.

Then, the controller 11A organizes a management group for k reuse blocks in the extracted block group, and rewrites the contents of the management group information 501 with the physical block numbers of reuse blocks included in the management group (step S33).

Then, in the extracted reuse block group, the controller 11A employs a reuse block not included in the management group as “a remainder reuse block,” and appends the physical block number of the remainder reuse block to the remainder block information 502 (step S34).

Then, the controller 11A determines whether k remainder reuse blocks are included in the remainder block information 502 (step S41).

If it is determined in step S41 that k remainder reuse blocks are included in the remainder block information 502, the process proceeds to execute step S42 that follows. That is, in the management group information 501, the controller 11A rewrites a group of physical block numbers associated with respective k blocks to a group of physical block numbers of k remainder reuse blocks indicated in the remainder block information 502 (step S42).

Then, in the physical block information 201, the controller 11A rewrites the state information associated with one of the k remainder reuse blocks indicated in the remainder block information 502 from “no good” to “good” (step S43).

Then, the controller 11A deletes the contents of the remainder block information 502 (step S44).

After step S44 above has been executed or in step S41 above, if it is determined that the remainder block information 502 does not include k remainder reuse blocks, the controller 11A proceeds to execute step S45 that follows. That is, the controller 11A acquires the physical ID corresponding to the state information indicative of “no good” from the physical block information 201 as a no-good physical ID (step S45).

Then, in the conversion table 202, the controller 11A rewrites the physical ID corresponding to a logical address corresponding to the no-good physical ID to a physical ID corresponding to the state information indicative of “good” (step S46).

Upon reception of a logical address sent out from the host device 50 after step S46 above has been executed, the controller 11A executes the access block number determination process as below. This allows for determining the physical block number indicative of a block to be accessed.

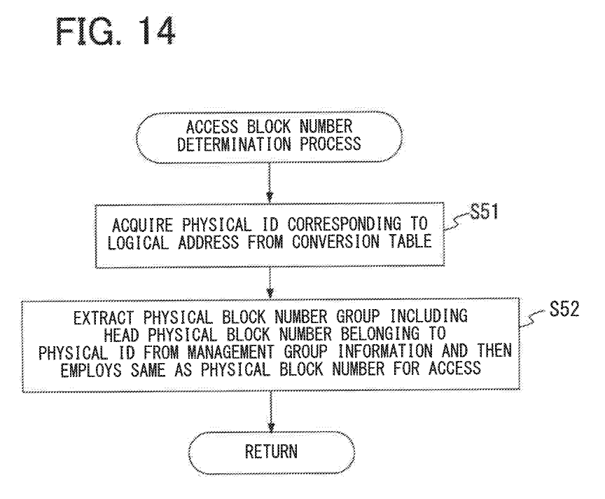

FIG. 14 is a flow chart illustrating another example of the access block number determination process.

In FIG. 14, the controller 11A acquires the physical ID corresponding to the logical address from the conversion table 202 (step S51).

Then, the controller 11A extracts a physical block number group including the head physical block number that belongs to the physical ID mentioned above from the management group information 501, and employs each physical block number as a physical block number for access (step S52).

The controller 11A provides control to the memory cell array 10 so as to access (read or write) each block represented by the physical block number group acquired in the aforementioned step S52.

The management information (201, 202, 501, 502) is updated as mentioned above on the RAM 12 and the management information region SA and the redundant region JA of the memory cell array 10.

Concerning the management information update process and the access block number determination process illustrated in FIGS. 12 to 14, a description will be given of the case where the number of blocks of a management group or “k,” which serves as the minimum unit for managing the state of blocks, is “2” by way of example.

### The Management Information Update Process

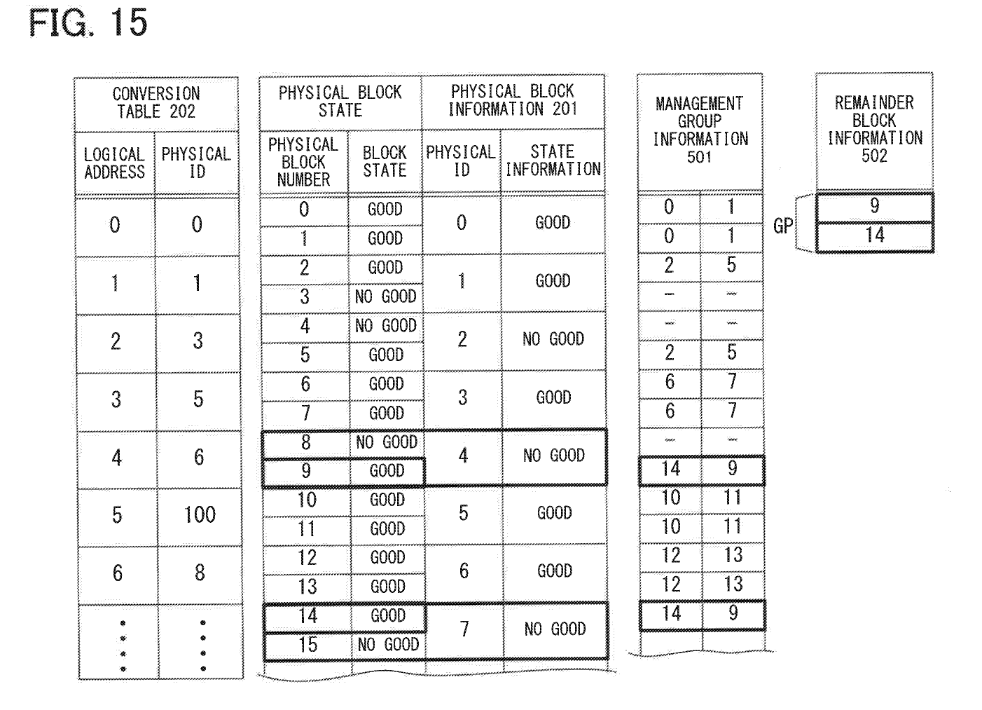

FIG. 15 is a view illustrating the contents of the management information (201, 202, 501, 502) which has been updated by the processing in the aforementioned steps S31 to S34, S41, and S42 when each block corresponding to the physical block numbers “3,” “4,” “8,” and “15” is sensed as a no-good block.

In the example shown in FIG. 15, it is assumed that two physical block numbers constitute one management group.

In FIG. 15, the two blocks denoted by the physical block numbers “0” and “1” constitute the management group, and in the physical block information 201, are assigned “0” as the physical ID indicative of this management group. Since the two blocks denoted by the physical block numbers “0” and “1” corresponding to the physical ID “0” are both in a good state, the state information corresponding to the physical ID “0” remains “good.”

Furthermore, the two blocks denoted by the physical block numbers “2” and “3” constitute a management group, and in the physical block information 201, are assigned “1” as the physical ID indicative of this management group. While the block corresponding to the physical block number “2” among the physical block numbers “2” and “3” corresponding to the physical ID “1” is in a good state, the block corresponding to the physical block number “3” is in a no-good state.

The two blocks denoted by the physical block numbers “4” and “5” constitute a management group, and in the physical block information 201, are assigned “2” as the physical ID indicative of this management group. While the block corresponding to the physical block number “5” among the physical block numbers “4” and “5” corresponding to the physical ID “2” is in a good state, the block corresponding to the physical block number “4” is in a no-good state.

The reuse blocks expressed by the physical block numbers “2” and “5” each indicative of a good state are combined to thereby set a reuse management group.

Therefore, as shown in FIG. 15, in the management group information 501, the physical block numbers “2” and “5” are set as the reuse management group associated with the physical block number “2.” Furthermore, the physical block numbers “2” and “5” are set as the reuse management group associated with the physical block number “5.”

Thus, the physical ID “1” is assigned the reuse management group from the combination of the physical block numbers “2” and “5.” In the physical block information 201, the state information indicative of “good” is set corresponding to the physical ID “1.”

Furthermore, in FIG. 15, the two blocks denoted by the physical block numbers “8” and “9” constitute a management group, and are assigned “4” as the physical ID indicative of the management group. While the block corresponding to the physical block number “9” corresponding to the physical ID “4” is in a good state, the block corresponding to the physical block number “8” is in a no-good state. Therefore, the state information corresponding to the physical ID “4” is rewritten to “no good.”

Furthermore, in FIG. 15, the two blocks denoted by the physical block numbers “14” and “15” constitute a management group, and are assigned “7” as the physical ID indicative of the management group. While the block corresponding to the physical block number “14” among the physical block numbers “14” and “15” corresponding to the physical ID “7” is in a good state, the block corresponding to the physical block number “15” is in a no-good state. Therefore, the state information corresponding to the physical ID “7” is rewritten to “no good.”

Both the aforementioned pieces of state information corresponding to the physical IDs “4” and “7” are indicative of “no good.” However, both the management groups corresponding to the respective physical IDs “4” and “7” include a block that is in a “good” state.

In this context, the physical block numbers “9” and “14” of the blocks that are in a “good” state, corresponding to the physical IDs “4” and “7,” respectively, are appended to the remainder block information 502 as a remainder reuse block.

In the remainder block information 502, those for the number of blocks constituting the management group, that is, the two physical block numbers “9” and “14” are present.

As shown in FIG. 15, this allows for setting the reuse management group GP by the combination of the remainder reuse blocks denoted by the physical block numbers “9” and “14.”

Therefore, as shown in FIG. 15, in the management group information 501, the physical block number “9” is associated with the reuse management group by the combination of the physical block numbers “9” and “14.” On the other hand, the physical block number “14” is associated with the reuse management group by the combination of the physical block numbers “9” and “14.”

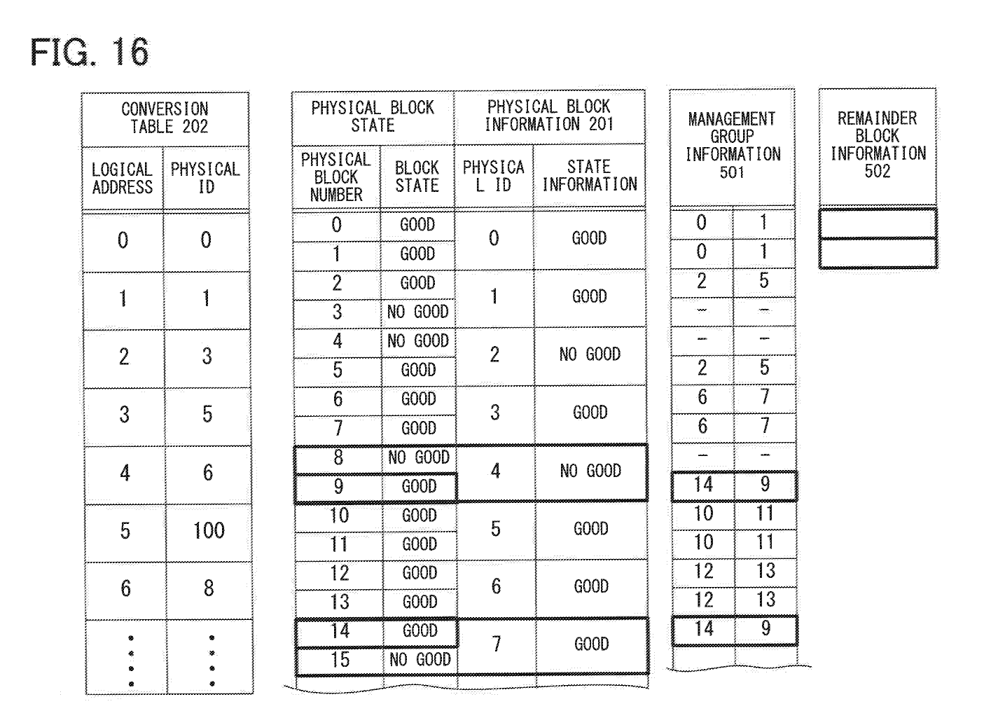

Then, as shown in FIG. 16, if the steps S43 and S44 are executed, the physical block information 201 and the remainder block information 502 are updated.

The physical ID “7” is made available by the reuse management group constituted by the combination of the head physical block number “14” and the physical block number “9.” Therefore, the state information corresponding to the physical ID “7” is rewritten to “good” as shown in FIG. 16. When the rewriting has been completed, the contents of the remainder block information 502 is erased as shown in FIG. 16.

The series of processes mentioned above make the physical ID “7,” which primarily was in a no-good state and thus could not be used, available.

### The Access Block Number Determination Process

A description will now be given of the access block number determination process that is executed in steps S51 and S52 shown in FIG. 14, for example, when the logical address “1” is supplied from the host device 50, on the basis of the management information (201, 202, 501) shown in FIG. 16.

According to the conversion table 202 shown in FIG. 16, the physical ID corresponding to the logical address “1” is “1.” Furthermore, according to the physical block information 201, the physical block numbers that belong to the physical ID “1” are “2” and “3.” According to the management group information 501, the management group corresponding to the physical block number “2” includes the physical block numbers “2” and “5.” Therefore, the physical block numbers “2” and “5” serve as an access block number.

As described above, in the memory system 100 shown in FIG. 10, the controller 11A provides control in the following manner to the plurality of blocks of the memory cell array 10A in which the blocks formed therein each include a plurality of memory cells and to a management group including k blocks.

First, for each of a plurality of management groups each including k blocks, the controller 11A produces the physical block information 201 which correspondingly indicates the state information indicative of “no good” when a no-good block is present in the management group.

Here, for each management group associated with the state information indicative of “no good” among the plurality of management groups, the controller 11A sets, as a reuse block to the remainder block information 502, a block other than the no-good block of the k blocks included in the management group. Then, when the total number of the reuse blocks set for each management group in the remainder block information 502 is k, the k reuse blocks are set as a new management group.

As described above, in the memory system 100, among the plurality of blocks included in the management group that is treated as being in a no-good state because a no-good block is included therein, the blocks in a good state other than the no-good block are reused to set a new management group.

This makes it possible to significantly reduce the apparent number of no-good blocks while preventing an increase in the capacity of management information. Furthermore, since the efficiency of using blocks is significantly improved, it is possible to implement an elongated memory service life, and accordingly reduce costs of the system.

Furthermore, according to the management group information 501, it is possible to directly know the physical block number of the management group corresponding to the physical ID. Therefore, like the memory system 100 shown in FIG. 1, when compared with the case where the head physical block number of the management group is used for computation to thereby determine another physical block number, it is possible to implement an increased access speed.

Note that in the aforementioned embodiments, the NAND flash memory is employed as the memory cell array 10 (10a). However, it is also acceptable to employ any memory so long as the memory is a so-called rewritable nonvolatile semiconductor memory such as a NOR-type flash memory.

It is understood that the foregoing description and accompanying drawings set forth the preferred embodiments of the present invention at the present time. Various modifications, additions and alternative designs will, of course, become apparent to those skilled in the art in light of the foregoing teachings without departing from the spirit and scope of the disclosed invention. Thus, it should be appreciated that the present invention is not limited to the disclosed Examples but may be practiced within the full scope of the appended claims. This application is based upon and claims the benefit of priority from the prior Japanese Patent Application No. 2017-064935 filed on Mar. 29, 2017, the entire contents of which are incorporated herein by reference.

What is claimed is:

1. A memory system comprises:
a memory cell array with a plurality of blocks each including a plurality of memory cells; and
a controller configured to, for each of a plurality of management groups each including k pieces of said blocks (k is an integer equal to two or greater), produce physical block information correspondingly indicating state information indicative of no good when a no-good block is present in said management group, wherein
for each management group associated with said state information indicative of no good, said controller sets, as a reuse block, a block other than said no-good block among said k pieces of said blocks included in said management group, and when a total number of said reuse blocks is k, sets said k pieces of the reuse blocks as a new management group.

2. The memory system according to claim 1, wherein said memory cell array is provided with a management information region in which a physical block number indicative of said reuse blocks is stored in conjunction with said physical block information.

3. The memory system according to claim 2, wherein
said controller
senses, as said no-good block, a block with unsuccessfully written data among blocks in which data has been written in response to a write access from an external device, and
when said no-good block is sensed, updates said state information associated with said management group including said sensed no-good block to a state indicative of no good.

4. The memory system according to claim 3, wherein when said no-good block is sensed from among said k reuse blocks included in said new management group, said controller sets said new management group to a no-good state and as well appends, to said management information region, a physical block number of blocks excluding said no-good block from said k reuse blocks included in said new management group.

5. The memory system according to claim 1, wherein management group information is associated with each of said plurality of blocks and stored in said memory cell array, said management group information being indicative of said physical block number of each block included in said management group.

6. The memory system according to claim 5, wherein
said memory cell array comprises a NAND type flash memory, and
said management group information is stored in a redundant region of at least one page of each of said plurality of blocks.

7. A method for managing a memory, said method comprising:
for each of a plurality of management groups each including k pieces of blocks (k is an integer equal to two or greater), producing physical block information correspondingly indicating state information indicative of no good when a no-good block is present in said management group;
for each management group associated with said state information indicative of no good, setting as a reuse block, a block other than said no-good block among said k pieces of said blocks included in said management group; and
when a total number of said reuse blocks is k, setting said k pieces of said reuse blocks as a new management group.

8. A semiconductor device comprising:
a controller configured to, for each of a plurality of management groups each including k pieces of blocks (k is an integer equal to two or greater), produce physical block information correspondingly indicating state information indicative of no good when a no-good block is present in said management group, wherein
for each management group associated with said state information indicative of no good, said controller sets, as a reuse block, a block other than said no-good block among said k pieces of said blocks included in said management group, and when a total number of said reuse blocks is k, sets said k pieces of the reuse blocks as a new management group.
